(19) United States
(12) Patent Application Publication
(10) Pub. No.: US 2012/0181214 A1
(43) Pub. Date: Jul. 19, 2012

(54) STRUCTURE AND PROCESS FOR RECYCLING CONTAINERS

(75) Inventors: Thomas C. Kernen, Rubicon, WI (US); Gina Kernen, Rubicon, WI (US)

(73) Assignee: Kard Reclycling Service, Inc., New Berlin, WI (US)

(21) Appl. No.: 13/176,384

(22) Filed: Jul. 5, 2011

Related U.S. Application Data
(60) Provisional application No. 61/399,059, filed on Jul. 6, 2010.

(51) Int. Cl. B65D 19/02; B65G 57/03; B65D 21/02

(52) U.S. Cl. 206/596; 414/802

(57) ABSTRACT

A container for use in handling recyclable paper products is disclosed. The container has an open top and includes a plurality of openings formed near its upper edges for receiving fork lift truck tines. A method of nesting empty containers is also disclosed.

### RELATED APPLICATIONS

This application claims the benefit of U.S. Provisional Patent Application Ser. No. 61/399,059, filed 6 Jul. 2010.

### BACKGROUND OF THE INVENTION

This invention relates to containers for materials to be recycled such as paper, cardboard, newsprint and other recyclable media and the use of said containers. In the paper products recycling industry, paper products to be recycled are typically brought into a recycling facility in containers of various sizes and configurations. For example, recyclable paper products from an office may arrive in a small container having wheels. The container is sized so that it can be easily moved into, around and out of an office building including fitting through doorways. In an industrial facility, recyclable paper products may be gathered in a larger container, such as a dumpster. The dumpster may be transported to the recycling facility or the dumpster may be emptied on site and the contents delivered to the recycling facility by truck.

Once the recyclable materials arrive at the recycling facility, there is a need to place the materials into uniformly sized containers that can be easily moved around the recycling facility.

Like any business, a recycling facility must make efficient use of its work space. The cost of work space is typically determined by the square footage of the floor space rented or utilized by the recycling facility. The less floor space required, the more efficient the facility can operate from a financial perspective. The containers utilized in a recycling facility are either filled with materials to be recycled or empty. In either instance it is important that the containers be stackable so that the floor space required for the storage of containers (either filled or empty) is minimized.

It is also more efficient to move multiple containers at the same time with the same equipment as compared to moving each container individually. When full containers are stacked, a cover is typically placed over the open top of the lower container and the bottom of the stacked container is placed on the top of the cover. Depending upon the weight of the contents, multiple full containers may be stacked upon one another. When empty, containers can often be nested one inside another. In this configuration, the cover is not utilized. Multiple nested containers can be moved through the recycling facility by a single fork lift truck making a single trip. The amount of floor space required to store a stack of nested containers is the same amount of space required to store a single container.

Prior art recycling containers are made from a variety of materials including paperboard, steel and plastic. Typically, the containers are open topped vessels with four upright sides connected to a bottom. The containers utilized in the recycling industry are sufficiently large to hold a substantial amount of paper products for recycling. Such containers, whether full or empty, are not moveable by hand. It is necessary to employ the use of a separate device, such as a forklift truck or hand truck to pick up and move containers of the size utilized in the recycled paper products processing industry.

In other industries, such as the food processing industry, it is common to use similarly large containers for the handling and storage of food. See for example U.S. Pat. No. 4,042,111 to Smith. It is typical, as taught by the Smith patent, to provide structure in the bottom of the container to allow a fork lift truck or pallet jack to pick up and move the container.

### SUMMARY OF THE INVENTION

The principal object of this invention is to provide a nestable container for the handling and storage of recyclable material comprising a unitary molded plastic body having openings near the top of the container for receiving fork lift tines. The nestable container of the present invention comprises a unitary molded plastic body having four upstanding sides and a bottom, at least two of the sides have a reinforced rib at their uppermost top edge, a pair of openings being formed in each of the reinforced ribs, and each opening in each rib on one side being aligned with an opening in the rib on the opposite side so that a fork lift truck tine may be passed through one opening, across the open top of the container and through a second opening.

The present invention may also include a removable cover for covering the open top of the container. The removable cover includes structure on its top surface, such as a pair of parallel ridges, for receiving similar structure formed in the bottom of a container to be stacked upon the covered container.

Another object is the process or method used to stack multiple empty containers one within another. In order to achieve this objective, a plurality of openings are formed in a first container near its upper edge, a fork lift truck tine is placed through said openings, the first container is lifted to a predetermined height, the first container is placed over a second container and the first container is lowered into the second container. The first container is removed from the second container by reversing the method.

The provision of the openings along the uppermost edge of at least two of each container's opposed side walls provides many advantages. A first container can be lifted with a fork lift truck and placed within a second container. Multiple empty containers can be nested one within another utilizing a fork lift truck for efficient storage. Once nested, multiple containers can also be moved throughout a facility simultaneously.

### BRIEF DESCRIPTION OF THE DRAWINGS

FIG. 1 is a top perspective view of the container;

FIG. 2 is a top plan view of the container;

FIG. 3 is a front elevation view of the container;

FIG. 4 is a side elevation view of the container;

FIG. 5 is a top perspective view of the container with a lid;

FIG. 6 is a front elevation view of a stack of nested containers, the top container having a lid;

FIG. 7 is a front elevation view of a stack of nested containers;

FIG. 8 is a perspective view showing fork lift truck tines passing through tine receiving openings in the container; and

FIGS. 9 through 14 show the steps for nesting and transporting multiple containers.

### DESCRIPTION OF THE PREFERRED EMBODIMENT

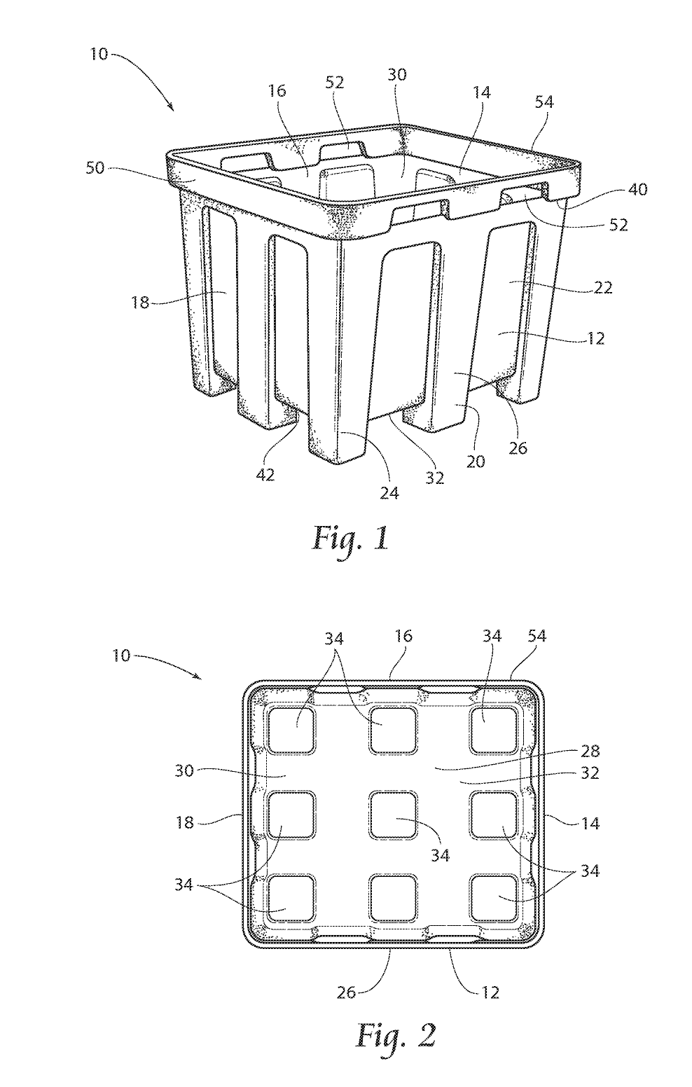

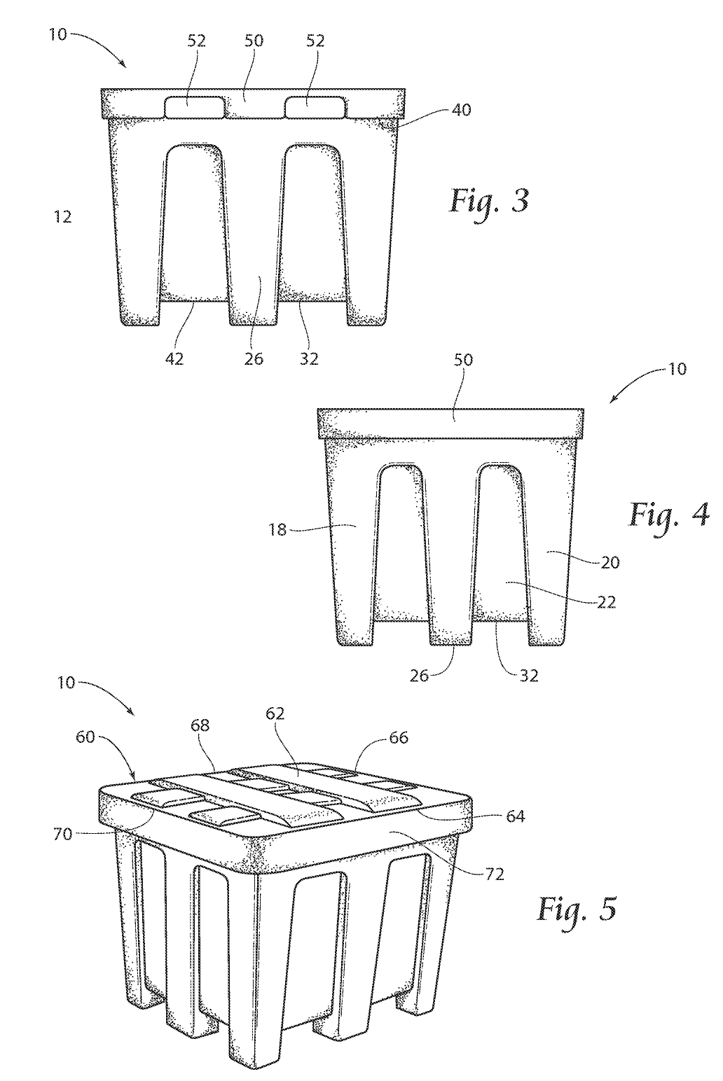

As seen in FIGS. 1 through 4, the container 10 comprises a unitary molded plastic vessel having four upright walls 12, 14, 16, 18, an open top 30 and a bottom wall 32. Each of the upright walls has protruding portions 20 and receding portions 22 which provide structural integrity to each upright wall. Each upright wall 12, 14, 16, 18 has an upper edge 40 and lower edge 42. Moving from the upper edge 40 of each upright wall to the lower edge 42, the wall 12, 14, 16, 18 is slightly tapered inwardly toward the center of the vessel which aids in the ability of multiple containers 10 to nest with one another as will be described herein in detail. Each upright wall 12, 14, 16, 18 has a thickness of approximately 0.25 inches.

A reinforced continuous rib 50 is formed about the upper edges 40 of each side wall 12, 14, 16, 18. The reinforced rib 50 is about four times thicker in cross section than the thickness of each sidewall. Preferably, the rib 50 is about one inch thick. Rectangular openings 52 are formed within the reinforced rib 50 on opposite side walls. The openings 52 are sized to receive the tines of a fork lift truck as will be described below in more detail. In the figures an embodiment is shown having a reinforced rib 50 formed about the upper edges 40 of each side wall 12, 14, 16, 18, and openings 52 in only two of the reinforced ribs 50. Other embodiments may have a reinforced rib 50 on only two opposing side walls 12, 14, 16, 18, or openings 52 in each reinforced rib 50.

Furthermore, FIG. 5 illustrates that the reinforced rib may also support a removable cover 60 that can be placed over the container 10 to close the open top 30. The cover 60 includes a top panel 62 having four sides 64, 66, 68, 70 and a downwardly depending lip portion 72 protruding from each side. The lip portion 72 fits around the outer periphery 54 (see FIGS. 1 and 2) of the reinforced rib 50 so that the cover 60 does not slide off of the container 10.

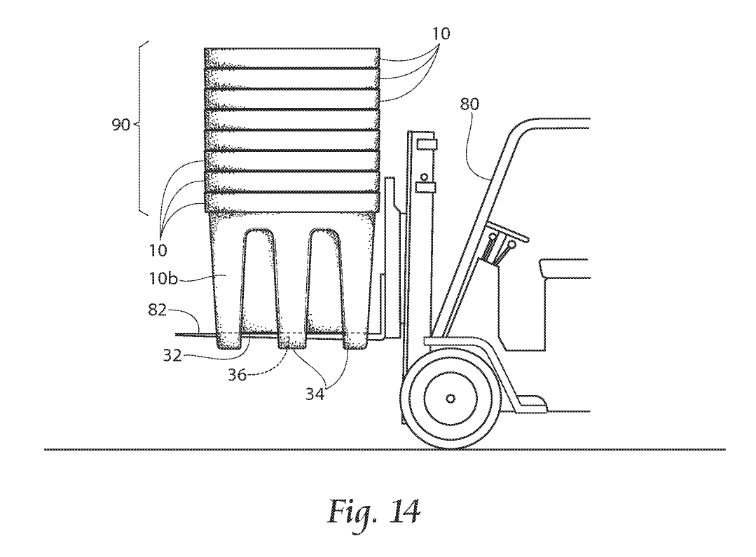

As seen in FIGS. 2 and 14, the bottom wall 32 includes at least eight rectangular protrusions 34 arranged to define four passageways 36 for receiving fork lift truck tines. A rectangular protrusion 34 is formed near each corner 24 of the container 10 and a rectangular protrusion 34 is formed in the mid section 26 of each upright wall 12, 14, 16, 18 just below its lower edge 42. The structure of the rectangular protrusion may extend upwardly into the upright walls 12, 14, 16, 18 to form the protruding portions 20 and receding portions 22. The portions 20, 22 add to the structural integrity of the container 10. Additionally, there may be a rectangular protrusion 34 formed in the center of the bottom wall 32 to add additional support.

The four upright walls 12, 14, 16, 18 and bottom wall 32 define an interior space 28 for receiving recyclable materials. The space 28 may be closed by placing the cover 60 over the open top 30.

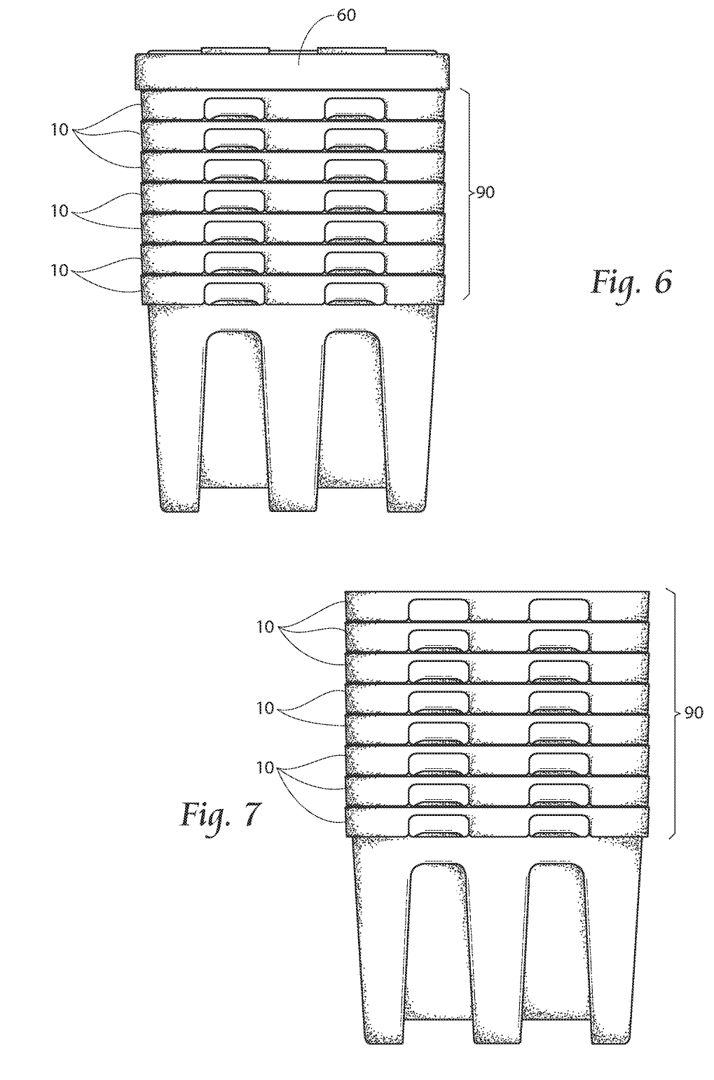

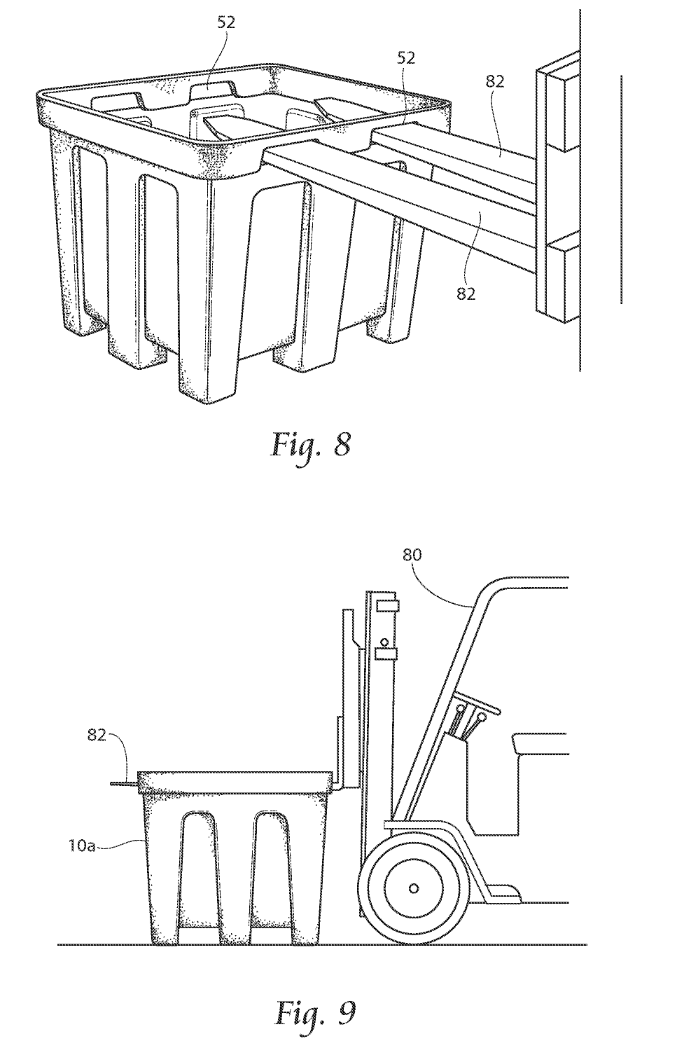

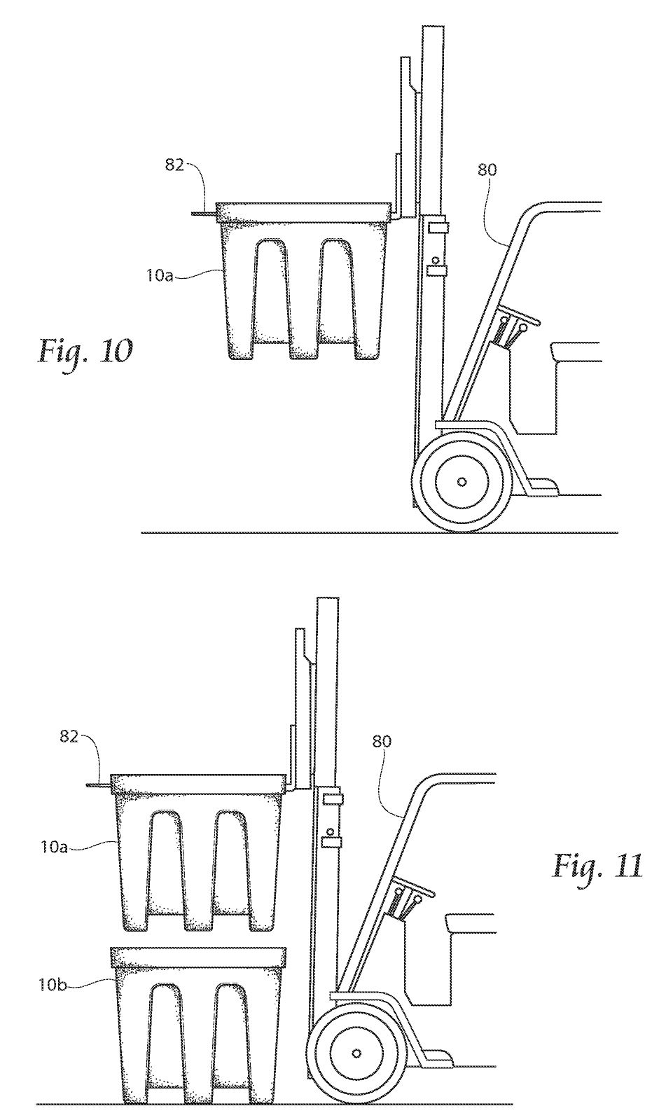

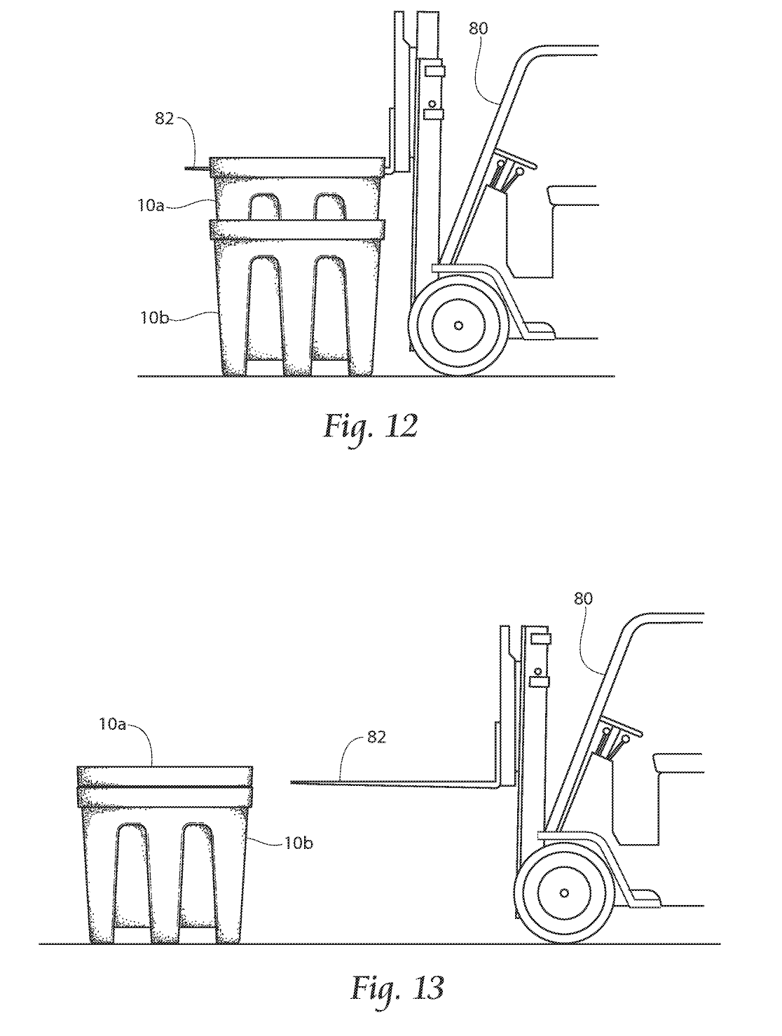

Looking to FIGS. 6 through 13, empty containers 10 can be nested when not in use. This is accomplished by utilizing a fork lift truck 80 having fork lift tines 82. The nesting method comprises first placing the tines 82 of a fork lift truck 80 in the rectangular openings 52 of a first container 10a, lifting the container 10a a predetermined distance upwardly, placing the lifted container 10a over a second container 10b, lowering the first container 10a into the second container 10b and removing the fork lift tines 82. This process can be repeated until the desired number of containers 10 has been nested one within the other to form a stack 90.

Typically the limitations on the number of containers 10 to be nested include the height of the room where the containers 10 are nested or whether the stack 90 of containers 10 needs to be transported to another room or placed within a vehicle. If the stack 90 needs to be moved to another room, the overall height of the stacked containers 90 is limited to the height of the doorway through which the stacked containers must be moved. Furthermore, if the stack 90 of nested containers is to be transported in a truck, the height must not exceed the height limitations of the truck box or similar enclosure.

Once stacked, as shown in FIG. 14, the forklift truck 80 can be utilized to lift the lowermost container 10b so that the stack 90 can be moved from one location to another. The fork lift truck tines 82 are passed through the fork tine passageways 36 defined by the rectangular protrusions 34 formed in the bottom wall 32 of the container 10.

The container 10 is preferably molded from plastic such as polyethylene and polystyrene. However, any material embodying the characteristics of strength and weight preferred for the intended use may be utilized. In addition, filler material may be blended with the plastic to increase its strength and durability.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

1. A stackable container comprising:
a unitary molded plastic vessel with a center, four upright walls, and a bottom wall with four sides, an interior surface, and an exterior surface;
the four upright walls each having an upper edge and a lower edge;
each of the four upright walls having a slight inward taper toward the center of the vessel from the upper edge to the lower edge;
the lower edge of each upright wall each in connection with a different side of the bottom wall;
each upper edge having a reinforced rib; and
each reinforced rib having two openings.

2. The stackable container of claim 1, wherein the upright walls each having at least one protruding portion and one receding portion.

3. The stackable container of claim 1, wherein each upright wall having a thickness of approximately 0.25 inches.

4. The stackable container of claim 1, wherein each reinforced rib is in connection with an adjacent reinforced rib making a continuous reinforced rib about the upper edge of the container.

5. The stackable container of claim 1, wherein each reinforced rib is about four times thicker than the thickness of each upright wall.

6. The stackable container of claim 1, wherein each reinforced rib is approximately one (1) inch thick.

7. The stackable container of claim 1, wherein only one pair of opposing upright walls have openings in their respective reinforced ribs.

8. The stackable container of claim 1, wherein the openings are rectangular in shape.

9. The stackable container of claim 1, wherein the openings are sized to receive tines of a fork lift.

10. A stackable container comprising:
four upright walls, each upright wall having a top and a bottom, wherein each upright wall's top being longer than its respective bottom;
the upright walls being configured to form a closed loop defining an interior space;
a bottom wall connected with the bottom of each upright wall and having an exterior surface;
the bottom wall having at least two passageways in the exterior surface; and
a reinforced rib positioned at the top of at least two of the upstanding walls, wherein each of the reinforced ribs have at least two openings, each opening in each reinforced rib being aligned with an opening in the reinforced rib of the opposing upstanding wall.

11. The stackable container of claim 10, wherein the upstanding walls have at least one protruding portion and at least one receding portion.

12. The stackable container of claim 10, wherein a removable cover extends over the interior space and the reinforced ribs of the upstanding walls, and extends, at least partially, alongside the reinforced ribs.

13. The cover of claim 12 having a top surface wherein a structure is formed for receiving a similar structure.

14. A method for nesting substantially empty containers comprising:
placing each tine of a fork lift through an opening in the reinforced rib of one upstanding wall of a first container and also through each opening in the reinforced rib of the opposing upstanding wall of the first container;
lifting the first container with the fork lift to a predetermined height;
positioning the first container over a second similar container;
lowering the first container into the second container; and
removing the fork lift tines from the openings.
